(19) United States
(12) Patent Application Publication
(10) Pub. No.: US 2006/0192718 A1
(43) Pub. Date: Aug. 31, 2006

(54) Wide band IC tag

(76) Inventors: Koji Ando, Kyoto-fu (JP); Keisuke Saito, Kyoto-fu (JP); Kosuke Hayama, Kyoto-fu (JP)

Correspondence Address: DICKSTEIN SHAPIRO MORIN & OSHINSKY LLP, 2101 L Street, NW, Washington, DC, 20037, US

(21) Appl. No.: 11/355,150

(22) Filed: Feb. 16, 2006

(30) Foreign Application Priority Data
Feb. 23, 2005 (JP) 2005-47265

(51) Int. Cl. H01Q 13/00

(52) U.S. Cl. 343/773; 343/795

(57) ABSTRACT

This invention provides a wide band IC tag having a wide frequency band and difficult to be influenced an object having a dielectric constant. Therefore, the wide band IC tag is formed by connecting an IC portion arranged in a tag main body and left and right antenna portions. The left and right antenna portions are constructed by respective plural antenna elements of different element lengths.

### BACKGROUND OF THE INVENTION

1. Field of the Invention

This invention relates to a wide band IC tag difficult to be influenced by an object having a dielectric constant of a metal, water, etc. in a RFID tag operated by a radio wave of a UHF band.

2. Background Art

As the above tag, a RFID tag 10 of a first related-art example using a dipole antenna 11 as shown in FIG. 10 is used. This dipole antenna 11 functions as an antenna at a resonance frequency depending on the element lengths of antenna elements 13, 13 connected to an IC portion 12. However, the resonance frequency of the antenna is easily influenced by the antenna circumference. The resonance frequency is moved when the tag is stuck to the object having the dielectric constant of e.g., a metal, water, etc., or when the object having the dielectric constant exists around the antenna. In this case, in the dipole antenna 11, the number of resonance frequencies is one, and its frequency band is generally narrow. Therefore, even when the resonance frequency is moved only slightly, it does not function as the antenna.

Further, in a RFID tag 20 of a second related-art example (see JP-A-2002-259934) having plural resonance frequencies as shown in FIG. 11, the element widths of antenna elements 22, 22 connected to an IC portion 21 are wide, and plural resonance frequencies are provided. Therefore, the frequency band functioning as the IC tag is widened. However, the antenna elements 22, 22 as conductors are formed on the entire tag face. Therefore, the antenna elements 22, 22 are greatly influenced by the object of the tag rear face. The resonance frequency is greatly moved by the influence of the object so that this tag does not function as the IC tag.

In other fields, many similar antenna structures exist, but their purposes are set to widen only the frequency band. Therefore, no influence of the tag rear face is reduced.

### SUMMARY OF THE INVENTION

In consideration of the above problems, an object of this invention is to provide a wide band IC tag having a wide frequency band and difficult to be influenced by the object substance.

A wide band IC tag according to an aspect of the invention is a wide band IC tag formed by connecting an IC portion arranged in a tag main body and left and right antenna portions, wherein the left and right antenna portions are constructed by plural antenna elements of different element lengths.

In accordance with this invention, resonance frequencies are different in accordance with the element lengths of the antenna elements. Therefore, if the left and right antenna portions are constructed by the plural antenna elements of different element lengths, the plural resonance frequencies are provided. Accordingly, even when a movement is made to a band not functioning with respect to the resonance frequency of one antenna element by the influence of an object having a dielectric constant, the resonance frequency of another antenna element is moved to a band functioning at a predetermined frequency (UHF band). Therefore, a communication function having a wide frequency band and high reliability as the IC tag is stably obtained.

A wide band IC tag according to another aspect of the invention has a structure in which the respective antenna elements are arranged in the order of the length from the antenna elements of a short element length to the antenna elements of a long element length in addition to the construction described above. In accordance with this invention, if the antenna element of a short element length arranged in the central portion is set to a reference and the respective antenna elements of different element lengths are arranged in the order of the length, the plural resonance frequencies can be provided. Further, if the plural resonance frequencies can be provided, the antenna element of a long element length arranged in the central portion is set to a reference, and the respective antenna elements of different element lengths may be also arranged in a shortening order.

A wide band IC tag according to another aspect of the invention has a construction in which the adjacent respective antenna elements are spaced at intervals for making these antenna elements not come in contact with each other, and are arranged in addition to the construction described above. In accordance with this invention, no antenna element as a conductor is formed on the entire tag face. Therefore, for example, even when the object having the dielectric constant of a metal, water, etc. exists on the tag rear face or around the antenna, it is difficult to have an influence.

A wide band IC tag according to another aspect, of the invention has a construction in which the respective antenna elements are arranged in a comb shape or a fan shape in addition to the construction described above. This invention has an intermittent structure in which a space or a clearance exists between the respective antenna elements. Therefore, it is difficult to have the influence of the object.

A wide band IC tag according to another aspect of the invention has a construction in which one end of each of the antenna elements is connected to the IC portion, and the other ends of the respective antenna elements are connected to each other in addition to the construction described above. In accordance with this invention, it is possible to have the plural resonance frequencies corresponding to the element lengths of the respective antenna elements.

A wide band IC tag according to another aspect of the invention has a construction in which the number of antenna elements is set to an arbitrary number in addition to the construction described above. In accordance with this invention, when an arbitrary number of antennal elements of different element lengths are arranged, the plural resonance frequencies are provided. Accordingly, the width of the frequency band functioning as the IC tag can be arbitrarily set, and the frequency band is widened in comparison with that of a dipole antenna. In an embodiment, the numbers of left and right antenna elements are respectively set to eleven, but may be also set to an arbitrary number such as two to ten, or eleven or more, etc.

A wide band IC tag according to another aspect of the invention has a construction in which one portion or the entire length of the antenna element is formed in a curve structure in addition to the construction described above. In accordance with this invention, while the respective antenna elements are set to different element lengths, it is possible to have the plural resonance frequencies corresponding to the element lengths of the respective antenna elements.

In accordance with this invention, since the plural antenna elements of different element lengths exist, the plural resonance frequencies are provided so that the frequency band is widened. Further, since no antenna element as a conductor is formed on the entire tag face, it is difficult to have an influence even when the object having the dielectric constant exists on the tag rear face or around the antenna. Thus, a communication function of high reliability as the IC tag is stably obtained.

In this invention, the purpose of being widely setting the frequency band and being difficult to be influenced by the object having the dielectric constant is attained by constructing the left and right antenna portions connected to the IC portion of the wide band IC tag using the plural antenna elements of different element lengths.

### BRIEF DESCRIPTION OF THE DRAWINGS

FIG. 1 is a plan view showing a wide band IC tag in which an antenna elements are arranged in a comb shape.

FIG. 2 is a plan view showing an example in which antenna element end portions of FIG. 1 are connected to each other.

FIG. 3 is a plan view showing the wide band IC tag in which the antenna elements are arranged in a fan shape.

FIG. 4 is a plan view showing an example in which the antenna element end portions of FIG. 3 are connected to each other.

FIG. 5 is a plan view showing a tag in which the antenna elements of a straight line type and a curve type are combined.

FIG. 6 is a plan view showing the tag in which the antenna element of the curve type is formed in a wavy shape.

FIG. 7 is a plan view showing the tag in which the antenna element of the straight line type is formed in a wavy shape.

FIG. 8 is a plan view showing the tag in which the antenna elements of the straight line type and the curve type are formed in a wavy shape.

FIG. 9 is a plan view showing the tag in which the antenna elements are arranged approximately in parallel with each other.

FIG. 10 is a plan view showing the tag using a dipole antenna of a first related-art example.

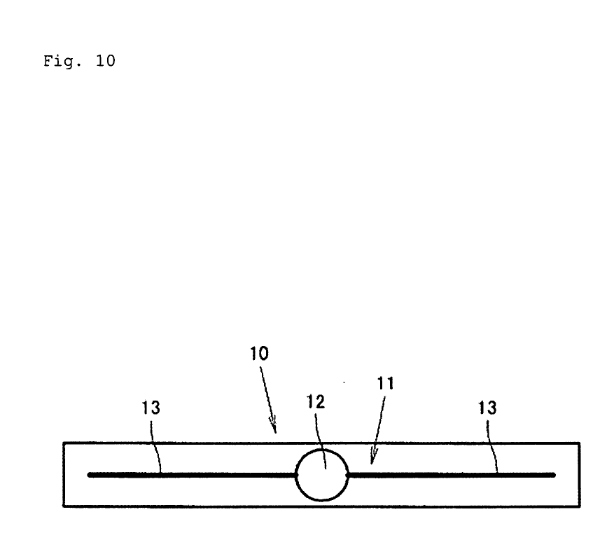

FIG. 11 is a plan view showing the tag in which an antenna element of a second related-art example is formed on the entire face.

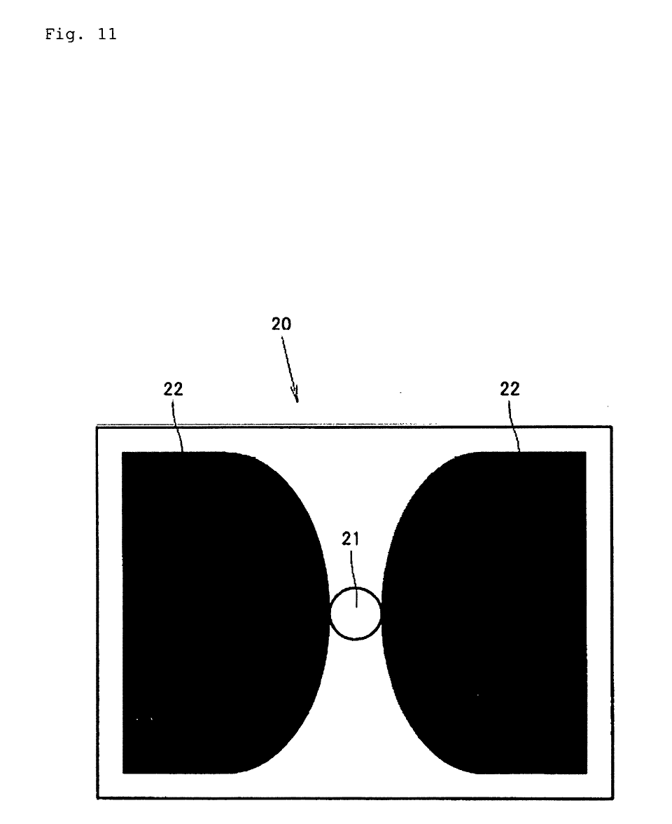

### DESCRIPTION OF THE PREFERRED EMBODIMENTS

One embodiment of this invention will next be described in detail on the basis of the drawings.

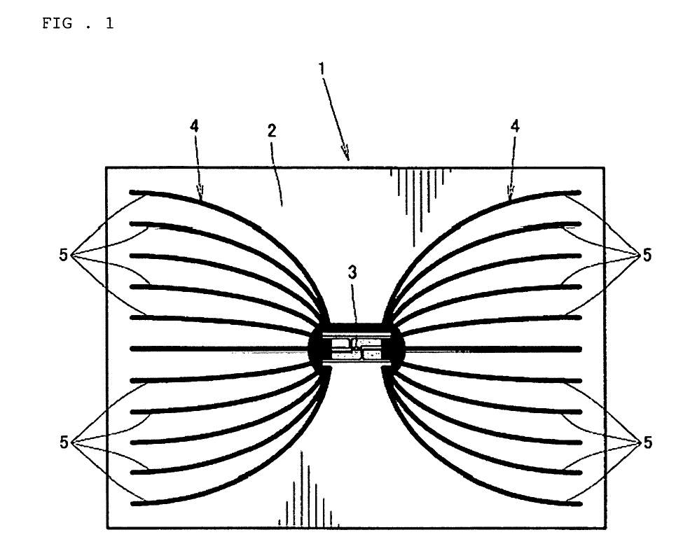

FIG. 1 shows a wide band IC tag 1 of a first embodiment mode in which respective plural antenna elements 5—of different element lengths in accordance with this invention are arranged in a comb shape. In this wide band IC tag 1, an IC portion 3 of a chip type arranged in the central portion of the surface of a tag main body 2, and left and right symmetrical antenna portions 4, 4 arranged in both side portions of the IC portion 3 along the surface of the tag main body 2 are electrically connected. The antenna portions 4, 4 are respectively constructed by eleven antenna elements 5—of different element lengths.

Terminal portions of the antenna portions 4, 4 are connected to the IC portion 3 arranged in the central portion of the above tag main body 2. The terminal portions of the antenna portions 4, 4 are connected to each other, and are arranged so as to match the impedances of the IC portion 3 and the antenna portions 4, 4.

Further, the antenna element 5 of a straight line structure of a short element length connected to left and right central portions of the IC portion 3 is set to a reference, and the respective antenna elements 5—of a curve structure of different element lengths connected to its upper and lower portions are arranged in an order lengthened toward the vertical direction.

Further, the respective antenna elements 5—of an arc shape of different curvature radii are arranged in an order increased toward the vertical direction, and the entire length of each antenna element 5—is formed in a smooth curve. In this embodiment, each antenna element 5—is set to the same element width, but may be also set to a different element width.

Further, the respective vertical adjacent antenna elements 5—are spaced at intervals for making these antenna elements not come in contact with each other and are arranged in a comb shape. These antenna elements 5—are also arranged in a radial direction so that the distance between the antenna elements 5 is gradually increased toward a direction farther from the IC portion 3, and are constructed by an inside removing structure in which a space or a clearance exists between the respective antenna elements 5. Otherwise, the respective vertical adjacent antenna elements 5—may be arranged at intervals for making no mutual interference or influence.

In accordance with this invention, resonance frequencies are different in accordance with the element lengths of the respective antenna elements 5—constituting the antenna portions 4, 4 connected to the IC portion 3. Therefore, if the left and right antenna portions 4, 4 are constructed by the respective plural antenna elements 5—of different element lengths, the plural resonance frequencies are provided corresponding to the element lengths of the respective antenna elements 5—. Therefore, even when a movement is made to a band not functioning with respect to the resonance frequency of one antenna element 5—by the influence of an object having a dielectric constant, the resonance frequency of another antenna element 5—is moved to a band functioning at a predetermined frequency (UHF band) . Therefore, the frequency band is widened.

Further, no antenna element 5 as a conductor is formed on the entire face of the tag main body 2. Therefore, even when the object having the dielectric constant exists on the rear face of the wide band IC tag 1 or around the antenna portion 4, it is difficult to have an influence. Thus, a communication function of high reliability as the wide band IC tag 1 is stably obtained. Further, for example, if an arbitrary number of antenna elements 5 such as two to ten, or eleven or more antenna elements 5, etc. are arranged, the width of the frequency band functioning as the wide band IC tag 1 can be arbitrarily set.

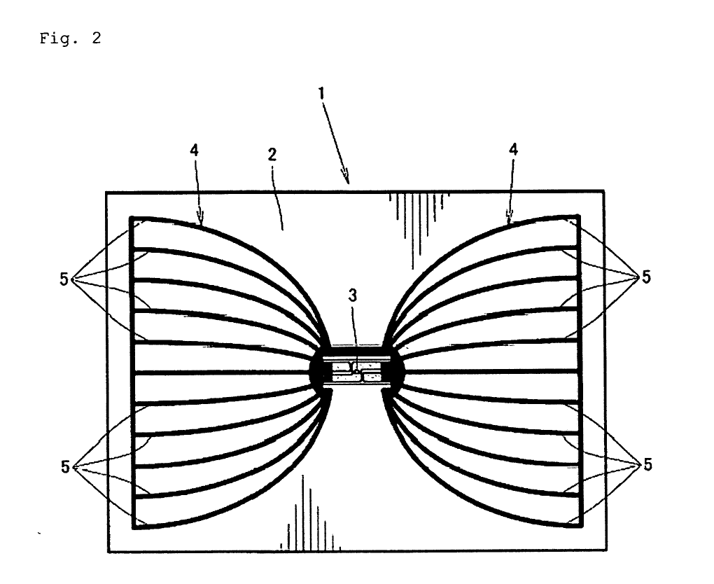

Further, as shown in FIG. 2, one end of each antenna element 5—may be connected to the IC portion 3, and the other ends of the respective antenna elements 5—may be also connected to each other. Thus, plural resonance frequencies corresponding to the element lengths of the respective antenna elements 5—can be provided. Accordingly, an operation and an effect approximately equal to those of the above first embodiment mode can be obtained.

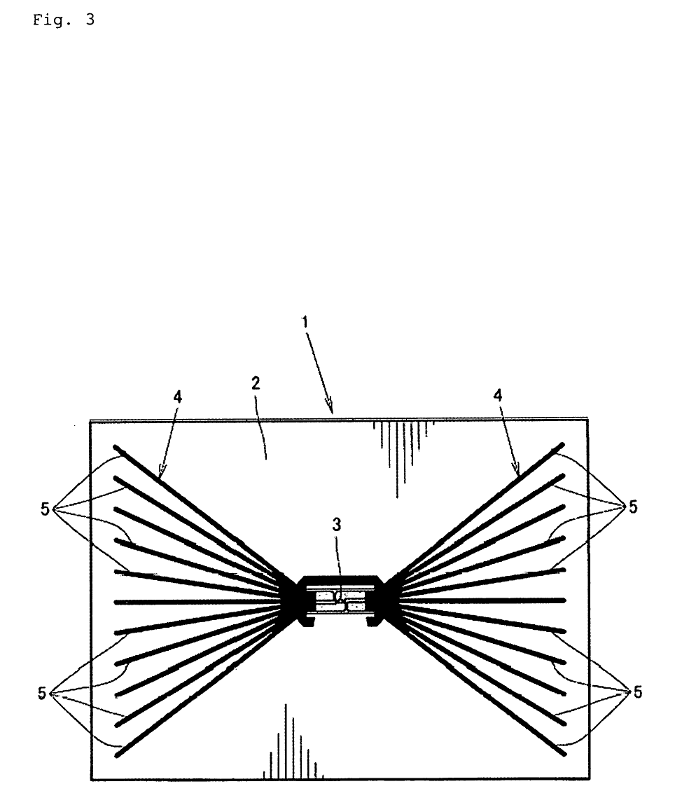

FIG. 3 shows a wide band IC tag 1 of a second embodiment mode in which each antenna element 5 is arranged in a fan shape. The antenna portions 4, 4 connected to the IC portion 3 are constructed by the respective antenna elements 5—of a straight line structure of different element lengths. Namely, the respective antenna elements 5—of different element lengths are spaced at a predetermined equal angle and are vertically arranged with the IC portion 3 as a center. Further, the antenna element 5 of a short element length connected to left and right central portions of the IC portion 3 is set to a reference, and the antenna elements 5 are arranged in an order lengthened toward the vertical direction.

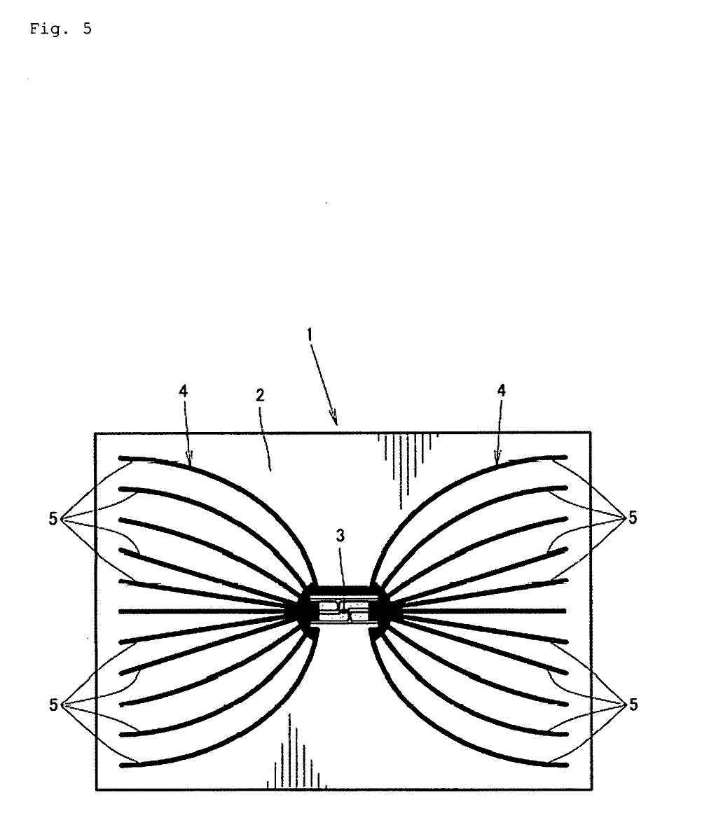

FIG. 5 shows a wide band IC tag 1 of a third embodiment mode in which the respective antenna elements 5—of a straight line structure and a curve structure are combined and arranged. The respective plural antenna elements 5—of the straight line structure constituting the left and right antenna portions 4, 4 are arranged in the left and right central portions of the IC portion 3. The respective plural antenna elements 5 of the curve structure are arranged above and below the respective antenna elements 5—of this straight line structure.

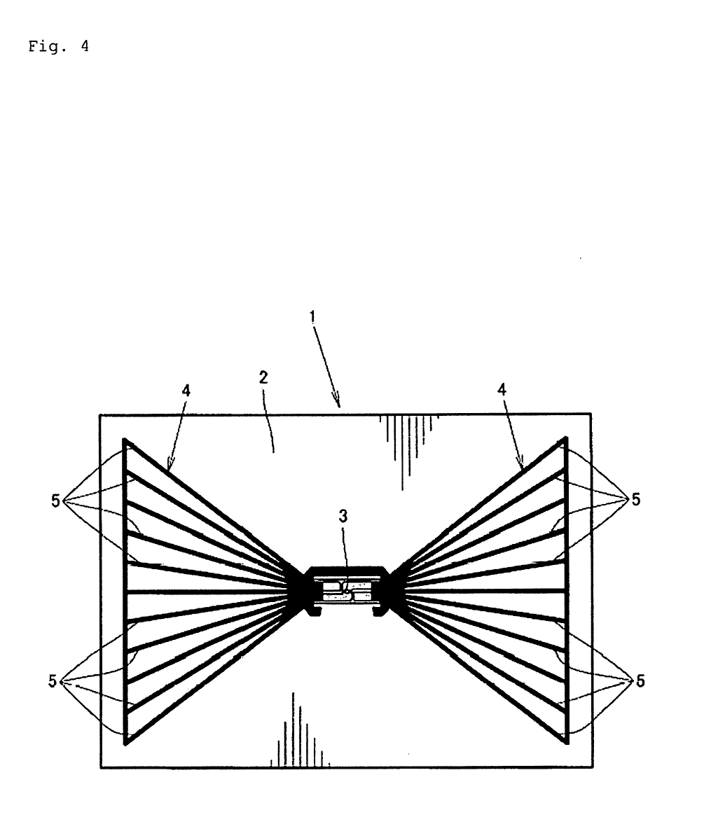

In accordance with this invention, since the element lengths of the respective antenna elements 5—of the straight line structure and the curve structure constituting the left and right antenna portions 4, 4 are different, the plural resonance frequencies corresponding to the element lengths of the respective antenna elements 5—are provided. Accordingly, an operation and an effect approximately equal to those of the above first embodiment mode can be obtained. Further, the respective antenna elements 5—of the straight line structure and the curve structure may be also alternately arranged. Further, as shown in FIGS. 2 and 4, end portions of the respective antenna elements 5—may be also connected to each other.

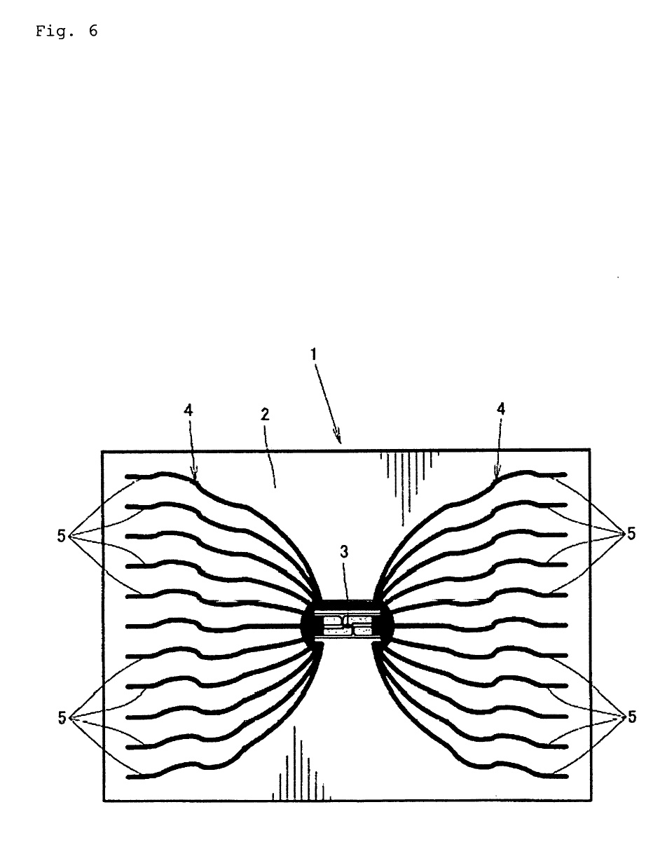

FIG. 6 shows a wide band IC tag 1 of a fourth embodiment mode in which the respective antenna elements 5 of the curve structure are formed in a wavy shape. The entire lengths of the respective antenna elements 5—of the curve structure constituting the antenna portions 4, 4 connected to the IC portion 3 are formed in a smooth wavy shape. Accordingly, plural resonance frequencies corresponding to the element lengths of the respective antenna elements 5—are provided. Accordingly, an operation and an effect approximately equal to those of the above first embodiment mode can be obtained. Further, the entire tag can be made compact while the different element lengths and the plural resonance frequencies are maintained.

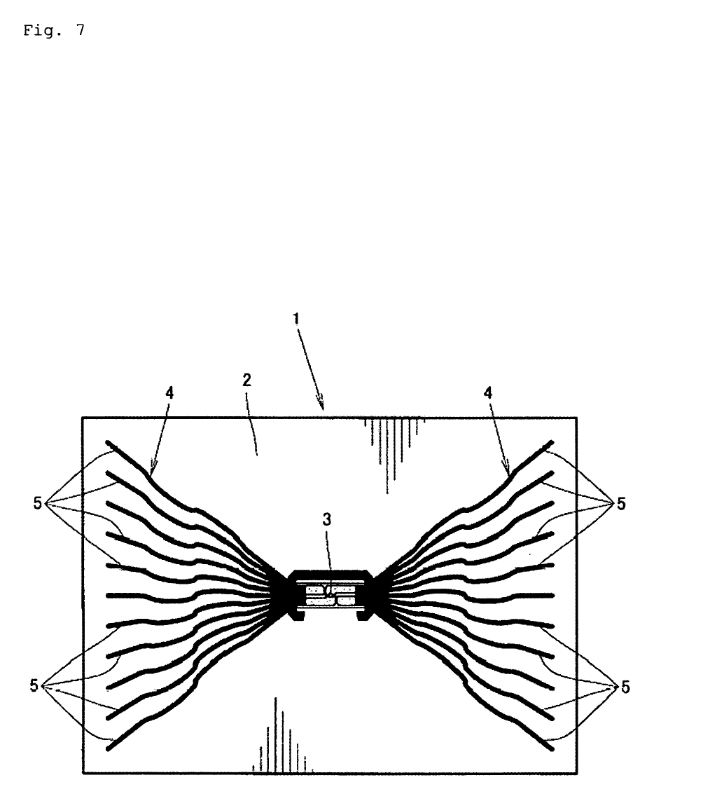

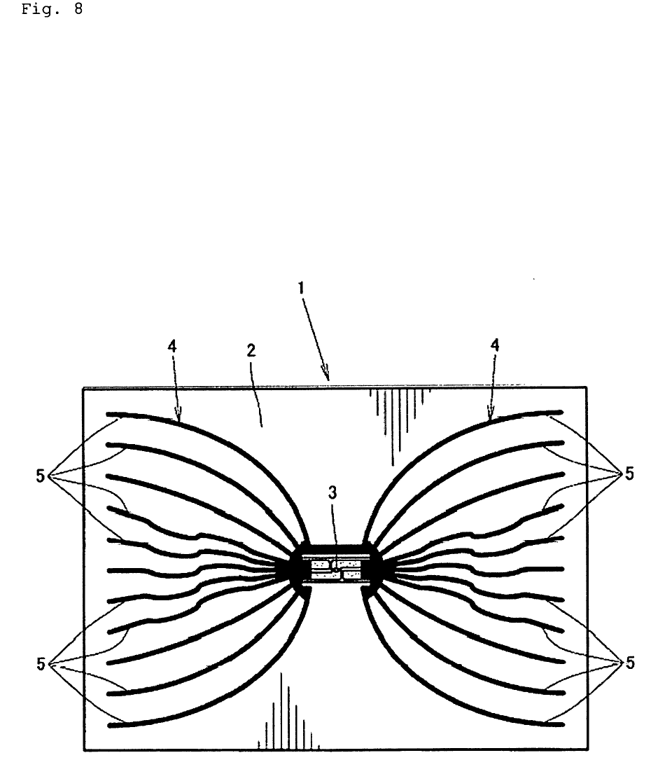

Further, as shown in FIG. 7, the entire lengths of the respective antenna elements 5—of the straight line structure are formed in a wavy shape. Otherwise, as shown in FIG. 8, the respective antenna elements 5 of the curve structure and the straight line structure are combined and arranged, and the entire lengths of these respective antenna elements 5—may be also formed in a wavy shape. One portion of the antenna element 5 may be also formed in a smooth wavy shape, or may be also formed in a meandering shape such as a triangular shape, a trapezoidal shape, etc. instead of the wavy shape.

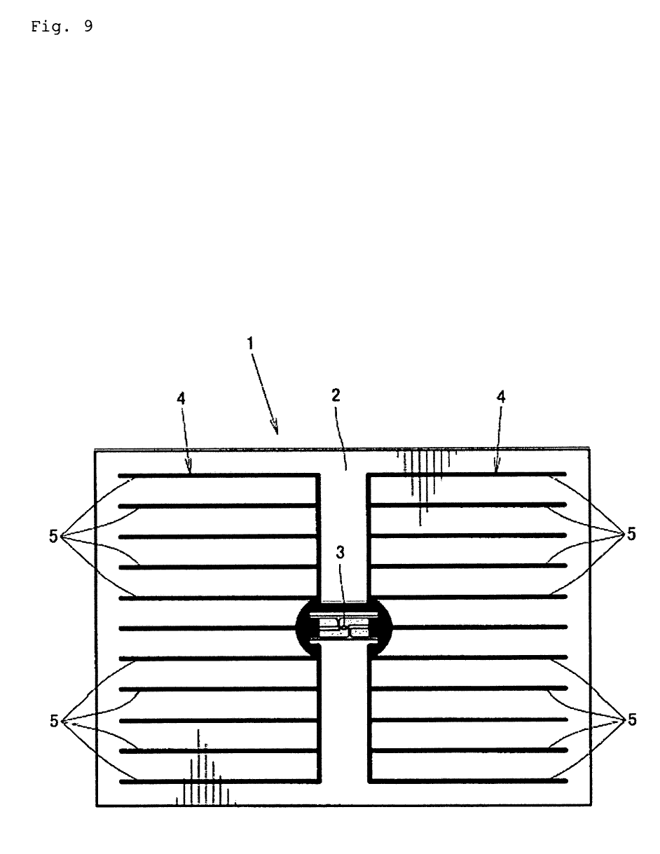

FIG. 9 shows a wide band IC tag 1 of a fifth embodiment mode in which the respective antenna elements 5—are arranged in a comb shape approximately in parallel with each other. The respective plural antenna elements 5—constituting the antenna portions 4, 4 connected to the IC portion 3 are spaced at a predetermined equal interval with respect to the vertical direction, and are arranged. Further, the respective antenna elements 5—are arranged in a comb shape approximately in parallel with each other.

In accordance with this invention, since the element lengths of the respective antenna elements 5—constituting the left and right antenna portions 4, 4 are different, plural resonance frequencies corresponding to the element lengths of the respective antenna elements 5—are provided. Accordingly, an operation and an effect approximately equal to those of the above first embodiment mode can be obtained. Further, as shown in FIGS. 2 and 4, endportions of the respective antenna elements 5 approximately arranged in parallel with each other may be also connected to each other.

This invention is not limited to only the constructions of the above embodiments, but can be applied on the basis of technical ideas shown in claims, and many embodiment modes can be obtained.

1. A wide band IC tag formed by connecting an IC portion arranged in a tag main body and left and right antenna portions, wherein said left and right antenna portions are constructed by plural antenna elements of different element lengths.

2. The wide band IC tag according to claim 1, wherein said respective antenna elements are arranged in the order of the length from the antenna elements of a short element length to the antenna elements of a long element length.

3. The wide band IC tag according to claim 1 or 2, wherein said adjacent respective antenna elements are arranged at intervals for making these antenna elements not come in contact with each other.

4. The wide band IC tag according to any one of claims claim 1, wherein said respective antenna elements are arranged in a comb shape or a fan shape.

5. The wide band IC tag according to claim 1, wherein one end of each of said antenna elements is connected to said IC portion, and the other ends of the respective antenna elements are connected to each other.

6. The wide band IC tag according to claim 1, wherein the number of said antenna elements is set to an arbitrary number.

7. The wide band IC tag according to claim 1, wherein one portion or the entire length of said antenna element is formed in a curve structure.
